(19) United States
(12) Patent Application Publication
(10) Pub. No.: US 2008/0093972 A1
(43) Pub. Date: Apr. 24, 2008

(54) Discharge Lamp Having a Tube-Like Envelope

(75) Inventors: Rene J. Hendriks, Eindhoven (NL); Fedde Westerterp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,217

(22) PCT Filed: Jul. 7, 2005
(86) PCT No.: PCT/IB05/52264

§ 371 Date: Jan. 17, 2007

(30) Foreign Application Priority Data
Jul. 20, 2004 (EP) 04103447.1

(51) Int. Cl. H01J 1/62

(52) U.S. Cl. 313/493

(57) ABSTRACT

A discharge lamp having a tube-like envelope (1,3) comprising an electrode (4) near at least one of the two ends of the envelope. The axis (5) of the electrode (4) is directed substantially perpendicular to the axis of the tube-like envelope (1,3). The ends of two pinch lead wires (7) are connected to the ends of the electrode (4) and a portion (10) of each pinch lead wire (7) is embedded in the material of the envelope (1,3). The electrode (4) is located nearer to the end of the tube-like envelope (1,3) than a part of the pinch lead wire (7) that is embedded in the material of the envelope (3), resulting in a uniform light emission up to almost the end of the envelope.

The invention is related to a discharge lamp having a tube-like envelope comprising an electrode near at least one of the two ends of the envelope, whereby the axis of the electrode is directed substantially perpendicular to the axis of the tube-like envelope, and whereby the ends of two pinch lead wires are connected to the ends of the electrode and whereby a portion of each pinch lead wire is embedded in the material of the envelope.

The other end of each of the two pinch lead wires comprises a contact pin. Said other ends reach outside the tube-like envelope, so that the contact pins extend outside the lamp, and can be connected to corresponding electric contacts for supply of current to the electrode in the envelope. The electrode can be a tungsten wire, which wire may be straight or somewhat curved. Preferably the wire is coiled, so that the electrode is coiled-shaped. The electrode extends along an axis, which axis is the axis of the coil in case of a coil-shaped electrode.

In particular, the lamp is a low-pressure mercury vapor discharge lamp, whereby the tube-like envelope is made of transparent glass. The tube-like envelope can be straight or curved. In general, the envelope comprises a substantially cylindrical wall and an end portion at each end of the cylindrical wall. The end portions are connected to the cylindrical wall to form the sealed envelope. The material of the cylindrical wall and the material of the end portions may be the same, in particular glass. The outside of the end portions of the lamp may be covered by a cover of a different material, in which material said contact pins may be fixed.

Such a discharge lamp is disclosed in U.S. Pat. No. 4,317,066, whereby the electrode is coil-shaped. This publication describes a lamp whereby the embedded portions of the pinch lead wires are positioned parallel with respect to each other and parallel to the axis of the envelope, and whereby the contact pins are fixed in the cover of the end portion of the tube-like envelope. The publication also describes a lamp whereby said embedded portions are mutually coaxial and directed perpendicular with respect to the axis of the envelope. Thereby, the contact pins are straight embedded portions of the pinch lead wires. The last mentioned lamp is described as an improvement of the first mentioned lamp, because it has an improved uniform illumination output along its entire length, i.e. the lamp has a shorter end part, where the light emission is reduced.

A uniform illumination by the lamp along a large portion of the length of the envelope of the lamp is an advantage in case the lamp is used for certain applications, for example in case such lamp is used for back lighting, or as lamp in a photocopying machine. In such applications there is not always much space to accommodate the less light emitting end parts of the tube-like envelope of the lamp. Therefore, it may be desired to shorten the less light emitting end part of the lamp.

The end part of the lamp has to accommodate the electrode as well as the pinch lead wires, and therefore a portion of the length of the envelope cannot fully be used for light emission. In particularly, a certain length at the end part of the envelope is required to accommodate the embedded portions of the pinch lead wires. Therefore, the pinch lead wires enter the space inside the envelope at a certain distance from the end of the envelope of the lamp.

To shorten such less emitting end part of the lamp, U.S. Pat. No. 4,317,066 proposes to position the embedded portions of the two pinch lead wires coaxially with respect to each other, and both perpendicular to the axis of the envelope, whereby the embedded portions are the contact pins. However, thereby said contacts pins have to be located at a distance of the end of the envelope, in order to be properly embedded in the material of the envelope. Furthermore, the distance between the ends of the two pinch lead wires is much less than the inner diameter of the cylindrical wall of the envelope, so that it is not possible to utilize the full inner diameter of the cylindrical wall to accommodate the electrode. Another disadvantage may be that such position of the pinch lead wires results necessarily in a different location of the electric contact pins of the lamp, which location deviates from the standard location of the pins.

The object of the invention is a discharge lamp having a tube-like envelope, whereby the less light emitting end part of the lamp is relatively short, and/or whereby substantially the full inner diameter of the inner wall of the cylindrical wall of the envelope can be utilized for accommodating the electrode.

To accomplish with that object, the electrode is located nearer to the end of the tube-like envelope than a part of the pinch lead wire that is embedded in the material of the envelope. Thereby, the path of the pinch lead wire from the contact pin to the electrode is curved, whereby near the electrode that path is directed towards the end of the envelope. Therefore, the electrode can be positioned nearer to the end of the envelope than parts of the pinch lead wires.

In one preferred embodiment, whereby at least a part of each of said embedded portions of the pinch lead wires is substantially located in a plane parallel to the axis of the envelope, the axis of the electrode is directed at an angle with respect to said plane, i.e. the plane containing said parts of the embedded portions of the pinch lead wires and positioned parallel to the axis of the tube-like envelope of the lamp. Preferably, said plane includes the axis of the envelope.

In case the tube-like envelope of the lamp is curved, said axis is the axis of the end part of the envelope. In order to be connected to the ends of the electrode, the part of each pinch lead wire inside the envelope, or even a part of the embedded portion of the pinch lead wire, is curved towards the ends of the electrode. Preferably, the electrode is a coil-shaped electrode.

In one preferred embodiment, said angle is 1020 or more, preferably 4020 or more, and more preferably said angle is about 90°, whereby the axis of the electrode is directed substantially perpendicular relative to said plane containing the embedded portions of the pinch lead wires and parallel to the axis of the tube-like envelope.

In an embodiment whereby at least a part of each of the said embedded portions of the two pinch lead wires is directed substantial parallel to the axis of the tube-like envelope, or make an angle of less than 45° with said axis, preferably the part of each pinch lead wire inside the envelope and including said embedded portion is curved at an angle of less than 90° (i.e. a sharp angle), more preferably at an angle of 80° or less. Thereby, the electrode can be located nearer to the end of the tube-like envelope than the curved part of the pinch lead wires, so that a uniform light emission along a maximal portion of the envelope can be obtained. In this embodiment the electrode can be located against the end wall of the tube-like envelope, whereby said portions of the pinch lead wires are embedded in the same end wall.

In one preferred embodiment, a curved part of each pinch lead wire is also embedded in the material of the envelope, which parts are located between the electrode and the cylindrical (tubular) wall of the envelope. In this embodiment, the material in which said curved parts is embedded forms a shield partially surrounding the electrode, which shield reduces darkening of the cylindrical wall near the end of the envelope of the lamp. Such darkening is caused by evaporation or sputtering of material from the electrode during operation of the lamp.

In a lamp, whereby the tube-like envelope comprises a substantial tubular (cylindrical) wall and two end walls connected to the ends of the tubular wall, preferably two protrusions of the material of an end wall are extending between the electrode and the tubular wall. Because of the relative short distance between the end wall and the electrode, relative small protrusions extending from the end wall will form a shield between the electrode and the tubular wall of the envelope of the lamp, so that darkening of the tubular wall is reduced.

The invention will now be further elucidated by means of a description of two embodiments of a low-pressure mercury vapor discharge lamp having a tube-like envelope comprising a coil-shaped electrode near at least one of the two ends of the envelope, whereby reference is made to the drawing comprising figures which are only schematic representations, in which:

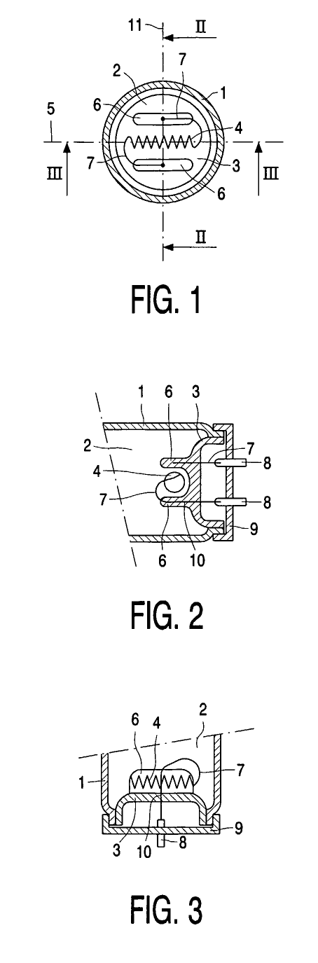

FIG. 1 is a sectional view in a radial plane of a lamp;

FIG. 2 is a sectional view according to the line II-II in FIG. 1;

FIG. 3 is a sectional view according to the line III-III in FIG. 1;

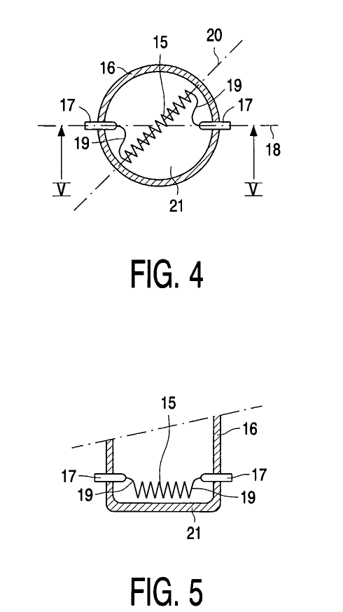

FIG. 4 is a sectional view in a radial plane of a second embodiment of a lamp, and

FIG. 5 is a sectional view according to the line V-V in FIG. 4.

FIG. 1 shows a first embodiment of the discharge lamp in a sectional view in a radial plane near one end of the envelope of the lamp. The cylindrical wall 1 of the envelope surrounds the sealed space 2 inside the envelope. A coil-shaped electrode 4 is present in front of the end wall 3 of the envelope. The axis 5 of the coil-shaped electrode 4 is positioned in the radial plane of the drawing. The cylindrical wall 1 and the end wall 3 are made of transparent glass and are sealed together to form the envelope of the lamp.

The end wall 3 is provided with two protrusions 6, extending in the sealed space 2 within the envelope of the lamp. One protrusion 6 is present at each side of the coil-shaped electrode 4 between the electrode 4 and the cylindrical wall 1, as is shown in FIG. 2. Two pinch lead wires 7 are present in order to energize the coil-shaped electrode 4, whereby the end of each pinch lead wire 7 is connected to an end of the coil-shaped electrode 4. The other end of each pinch lead wire 7 comprises a contact pin 8. The two contact pins 8 are fixed in a cover 9, which cover 9 is attached by means of glue to the end of the envelope of the lamp. The two contact pins 8 extend outside the lamp and can be connected to electrical contacts of a fitting (lampholder) of the lamp, so that the coil-shaped electrode can be energized.

A portion of pinch lead wire 7 is embedded in the material of the end wall 3 of the envelope and of protrusion 6. That portion is visible in FIGS. 2 and 3 because the material of the end wall 3 and the protrusion 6 is transparent glass. An embedded straight portion 10 of the pinch lead wire 7 is positioned parallel to the axis of the tube-like envelope, i.e. the axis of the cylindrical wall 1. Another embedded portion is curved towards the end of the coil-shaped electrode 4. The portion of the pinch lead wire 7 outside protrusion 6 is further curved, so that it can be connected with the end of the electrode 4. Thereby the total curve comprises an angle of less than 90° (a sharp angle). Therefore, the coil-shaped electrode 4 can be located near the end wall 3 of the envelope of the lamp.

The embedded straight portions 10 of the pinch lead wires 7 are substantially located in a plane containing also the axis of the envelope, i.e. the axis of the cylindrical wall 1. That is the plane of FIG. 2, which plane is positioned perpendicular to the plane of FIG. 1 and contains line 11 of FIG. 1. In this first embodiment, the axis 5 of the coil-shaped electrode 4 is directed perpendicular to said plane, so that the coil-shaped electrode 4 can be located between the two embedded straight portions 10 of the pinch lead wires 7. And furthermore, electrode 4 can extend over almost the entire inner diameter of the cylindrical wall 1 of the envelope 1.

FIG. 4 shows a second embodiment of the lamp. FIG. 4 is a sectional view through the radial plane at the location of the contact pins 17, near the end of the cylindrical wall 16 of the envelope of the lamp. In this second embodiment the two contact pins 17 are positioned coaxially on their common axis 18 and extend outside the cylindrical wall 16, so that they can contact corresponding electrical contacts of the fitting of the lamp (the lampholder). The two contact pins 17 comprise the embedded portions of the pinch lead wires 19. The axis of the coil-shaped electrode 15 is indicated with line 20.

In this second embodiment of the lamp, the plane containing the two embedded portions of the pinch lead wires (i.e. the two contact pins 17) as well as the axis of the cylindrical wall 16, extends perpendicular to the plane of FIG. 4 and comprises line 18. The axis 20 of the coil-shaped electrode 15 is directed at an angle of about 45° with respect to that plane, and therefore the length of the coil-shaped electrode 15 can be almost as long as the inner diameter of the cylindrical wall 16.

FIG. 5 is a sectional view according to the line V-V, and shows that the coil-shaped electrode 15 is located nearer to the end wall 21 of the tube-like envelope of the lamp than the contact pins 17. Therefore the pinch lead wires 19 are curved downwardly from the contact pins 17 to the end of the electrode 15.

The two embodiments of the tubular discharge lamp as described above are only examples; a great many other embodiments are possible.

1. A discharge lamp having a tube-like envelope (1,3;16,21) comprising an electrode (4;15) near at least one of the two ends of the envelope (1,3;16,21), whereby the axis (5;20) of the electrode (4;15) is directed substantially perpendicular to the axis of the tube-like envelope, and whereby the ends of two pinch lead wires (7;19) are connected to the ends of the electrode (4;15) and whereby a portion (10,17) of each pinch lead wire (7,19) is embedded in the material of the envelope (3;16), characterized in that the electrode (4;15) is located nearer to the end of the tube-like envelope than a part of the pinch lead wire (7;19) that is embedded in the material of the envelope.

2. A lamp as claimed in claim 1, whereby at least a part of each of said embedded portions of the pinch lead wires (7;19) is substantially located in a plane parallel to the axis of the envelope, characterized in that the axis of the electrode (5;20) is directed at an angle with respect to said plane.

3. A lamp as claimed in claim 2, characterized in that said angle is 10° or more, preferably 40° or more, and more preferably about 90°.

4. A lamp as claimed in claim 1, characterized in that the electrode (5;20) is a coil-shaped electrode.

5. A lamp as claimed in claim 1, whereby at least a part of each of said embedded portions (10) of the two pinch lead wires (7) is directed substantial parallel to the axis of the tube-like envelope (1), or make an angle of less than 45° with said axis, characterized in that the part of each pinch lead wire (7) inside the envelope (1) and including said embedded portion (10) is curved at an angle of less than 90°, preferably at an angle of 80° or less.

6. A lamp as claimed in claim 5, characterized in that a curved part of each pinch lead wire (7) is also embedded in the material of the envelope (3,6), which parts are located between the electrode (4) and the cylindrical wall (1) of the envelope.

7. A lamp as claimed in claim 1, whereby the tube-like envelope comprises a substantial tubular wall (1) and two end walls (3) connected to the ends of the tubular wall (1), characterized in that two protrusions (6) of the material of an end wall (3) are extending between the electrode (4) and the tubular wall (1).
